(19) United States
(12) Patent Application Publication
(10) Pub. No.: US 2006/0136277 A1
(43) Pub. Date: Jun. 22, 2006

(54) Automatic generation of a globalization project schedule

(76) Inventor: Benetta Neola Perry, Pflugerville, TX (US)

Correspondence Address: IBM CORPORATION;C/O DARCELL WALKER, ATTORNEY AT LAW, 9301 SOUTHWEST FREEWAY, SUITE 250, HOUSTON, TX, 77074, US

(21) Appl. No.: 11/014,057

(22) Filed: Dec. 16, 2004

(51) Int. Cl. G06F 9/46

(52) U.S. Cl. 705/8

(57) ABSTRACT

Project schedules do not include tasks for Globalization. This method defines and automatically creates globalization tasks that are to be performed during the development of an international product. In this method, a table is created containing various volumes of data and the amount of time required to translate each volume of data. For each volume of data, there is a corresponding translation productivity rate. When a globalization schedule is desired, a user inputs to the method of the present invention, a start date for the Globalization test effort and the date of the product release to manufacturing date. A user then moves the pointer of the constant representing a defined volume of data to the cell in the volume of data table to the volume that corresponds to their current volume for their product. The method then determines the amount of time needed to perform the globalization translation of the volume of data. The method then generates a globalization task schedule within a product development project. In addition, the present invention automatically creates an overall schedule and status report of milestones suitable for team and managerial distribution.

### FIELD OF THE INVENTION

This invention relates to a method for automatically generating project schedules and in particular to a method for automatically generating a schedule of globalization tasks that occur during the development phase of an international product.

### BACKGROUND OF THE INVENTION

A goal of companies is to produce a product that has appeal to as many people as possible. Many of these are international in scope in that customers in countries other than a product's country of origin will want the product. An example of this phenomenon is the automotive industry. Cars manufactured in one country are often sold to customers in other countries. However, during the design and development of the product, the primary focus is on engineering the design of the product such as it operates as designed.

Once there is a working model or prototype of a product, consideration can be given to adapting the product for markets in other countries. This adaptation of a product for distribution in countries other than the country of origin is known as “Product Globalization”. Again, with reference to an automobile, those in some countries such as the United States drive on the right side of a road or highway. Other countries, such as many in Europe people drive on the left side of the road. For a car that is manufactured in the United States to be sold in Europe, some features of the automobile must be modified to accommodate the driving style and rules of the country where the automobile will be sold.

The same product globalization process occurs for many electronic and computer products. With these types of products, one of the main considerations is having a product that can operate in a language other than the original language of the product. For example, a product developed in the United States is developed with English as the original language. The characters in the product are in English. The input information received by the product is in English. In addition, the information transmitted by the product is in English characters.

In the case of many products that have electronic or computer features, product globalization is necessary to ensure that the product can adequately function in many different language formats. The globalization process occurs within the larger product development process. The globalization process comprises an initial phase in which tests are performed to make sure that the original product model has the capability to accept language characters from languages other than the original product language. After the successful completion of this initial phase, there is a translation phase in which there is a determination of whether the product can function in a language other than the original language. A second translation phase involves the translation of documents and manuals that accompany a product to a language of a location in which the product will be sold. This document translation phase is known as the publication phase of product globalization. The globalization phase of the product development is crucial to many products that are designed for international markets. Product globalization is a “mini project” within a standard product development model. As with the product development process in general, product globalization has many activities and tasks that require completion before the product launch date. Therefore, it is necessary to develop schedules for the performance of these tasks as is done with tasks in any project.

Many product schedules are automatically generated. However, product globalization schedules are currently manually created traditionally using programs, such as, Microsoft Project. Updating a globalization schedule is tedious and prone to human error because the scheduling person must remember many formulas and dependencies related to the project. In addition, setting up globalization schedules using programs such as Microsoft Project is difficult. Currently, except for the manual approach, there is no other way to create a customizable overall high-level milestone in a status report format using schedule generating software such as Microsoft Project. In addition, there is not a consistent, mathematical, easily tailored method for creating a product globalization schedule. Current software scheduling products only have the functional ability to create a schedule and not a tailored status report. These products do not allow for the creation of customized functions, but just the linking of tasks.

There remains a need for a flexible and easy to use automated project globalization method that can generate customized product globalization schedules.

### SUMMARY OF THE INVENTION

It is an objective of the present invention to provide a method for automatically generating a schedule of globalization tasks, which occur during the development of a product.

It is a second objective of the present invention to create a table containing information about the time necessary to perform known tasks that are performed during the globalization phase of an international project.

It is a third objective of the present invention to provide a method for calculating translation productivity rates for various volumes of user visual text contained in the product.

It is a fourth objective of the present invention to provide a method for calculating translation productivity rates for various volumes of online help or printed text information contained in product documentation.

The present invention provides a method for automatically creating a schedule of globalization tasks that are performed during the development of an international product.

In this method, a table is created containing various volumes of data and the amount of time required to translate each volume of data. There are tables for both electronic data and hard copy data. For each volume of data, there is a corresponding translation productivity rate. When a globalization schedule is desired, a user inputs to the method of the present invention, a start date for the Globalization test effort and the date of the product release to manufacturing date. A user then moves the pointer of the constant representing a defined volume of data to the cell in the volume of data table to the volume that corresponds to their current volume for their product. The method then determines the amount of time needed to perform the globalization translation of the volume of data. The method then generates a globalization task schedule within a product development project.

In addition, the present invention automatically creates an overall schedule and status report of milestones suitable for team and management distribution. This invention eliminates the complexity in manually creating schedules for globalization tasks. The present invention significantly reduces the time required for updating. This invention gives an immediate impact to the overall Globalization project schedule when a target delivery date changes. This invention creates a consistent, mathematical, reproducible, easily tailored method for the creation of a Globalization project schedule. This invention required minimum inputs from the user (only 2 at this time).

Some of the advantages of the present invention are: 1) This invention is automatic and customizable 2) This invention creates and contains formulas that will be known and recognized as industry standard formulas 3) This invention puts all dependencies in one place with immediate impact notification 4) This invention creates in one work sheet all of the constants for generating a project schedule; 5) A user is able to program in another worksheet, all Globalization tasks and formulas needed using the constants; and 6) the invention has the ability to create in another worksheet, the automatic overall high-level schedule. 7) This invention combines the use of up to 4 applications generally used into 1 application, that is, from a PowerPoint or Word type application generally used for team status reporting, an application used for daily tracking of activities by the Globalization Project Manager and a MicroSoft Project type application generally used for the creation of schedules and a Excel type spreadsheet used for calculation of formulas, into one application, this invention, which contains and produces all these outputs. In the present invention, there are currently only two user inputs. In addition, the Excel spreadsheet sheet format allows for customization of the information generated in the scheduling reports.

### DESCRIPTION OF THE DRAWINGS

FIG. 1 is a flow diagram of the basic high-level activities that occur in the implementation of the present invention.

FIG. 2 is a general flow diagram of the detailed steps in the implementation of the method of the present invention.

FIG. 3 is a flow diagram of the steps in the implementation of the schedule generating steps of the present invention.

FIG. 4 is a chart correlating production week to an equivalent number of days for each week.

FIG. 5 is an illustration of a translation table used to calculate the translation time for the purpose of generating a globalization schedule in accordance with the present invention.

FIG. 6 is an illustration of a translation table used to calculate the translation time for the purpose of generating a globalization schedule for a volume of publication work in accordance with the present invention.

FIGS. 7a and 7b are illustrations of general and detailed scheduling reports for a globalization project generated in accordance with the method of the present invention.

### DESCRIPTION OF THE INVENTION

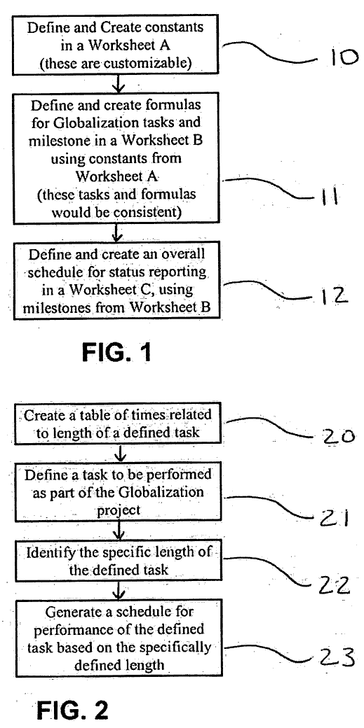

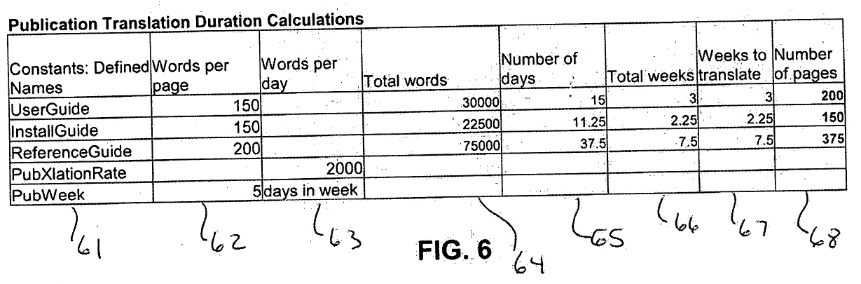

Referring to FIG. 1, shown is a flow diagram of the basic activities that occur in the implementation of the present invention. In order to create a product globalization schedule, it is necessary to know the amount of globalization (translation) work that is involved in that project. The translation work is the amount of text (English) that is in the project. The amount of text varies from product to product. The activity in block 10 defines and creates constants related to amounts of translation work that may occur in the project. Referring to FIG. 5, the first and second columns define constants based on intervals of 500 hundred lines of text. These constants represent the intervals of text that will be used by the user. Block 11 defines a formula for globalization tasks and milestones using the constants identified from Block 10. The formulas will determine that amount of time required to perform a translation task. Again referring to FIG. 5, columns five and six identify translation productivity rates. Block 11 defines the formula used to determine a translation time based on the amount of text to be translated and the identified translation rate. Block 12 uses the results from the calculations of Block 11 to generate overall schedule of the tasks for the project.

FIG. 2 is a general flow diagram of the steps in the implementation of the method of the present invention. In step 20, a general table is created describing tasks that are to be performed in a globalization project. As mentioned, this table contains volume intervals of text data for a particular project. A project can have several translation tasks such as a translation task for electronic text and a translation task for hardcopy documentation. Therefore a created table can have a section for electronic text as illustrated in FIG. 5 and a section for hardcopy documentation as illustrated in FIG. 6. In step 21, the user can define the task to be performed in the present process. The user would identify the type of translation such as a documentation translation or an electronic text translation. Step 22 identifies the volume/amount of data to be translated by the present method. Step 23 uses the inputs of steps 21 and 22 to first calculate the amount of time needed to perform the identified translation task. After the completion of the time calculations, this step generates a project globalization schedule based on the calculated times required to perform the identified tasks.

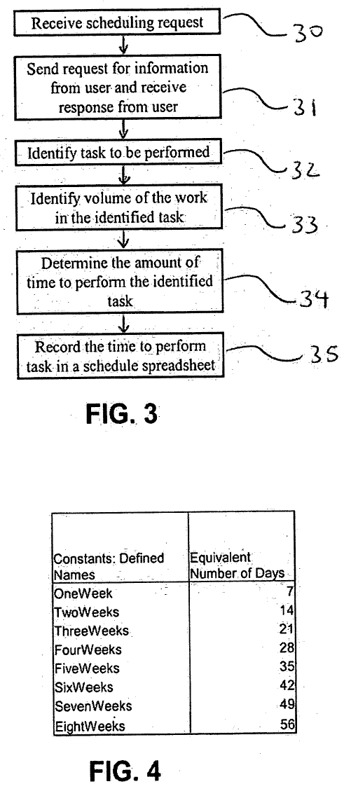

FIG. 3 is a flow diagram of the steps in the implementation of the schedule generating steps of the present invention. Step 30 of receives an initial scheduling request from a user. This request could be in form of a prompt or the clicking of an icon that activates the software of the method of this invention. After receiving the initial schedule request prompt, step 31 sends a prompt to the user requesting the particular data related to the globalization project. An alternate approach is a system in which the user supplies the information when the user submits the initial scheduling request. Step 32 identifies the translation task (electronic data or hardcopy documents) to be performed in this process. With this information, the process identifies which table or which formulas to use when calculating the time needed to perform the task. Step 33 identifies the volume of work constant supplied by the user. As mentioned, this constant will give a volume interval that is closest to the number of lines in text that needs to be translated in this project. At this point, step 34 determines the amount of time required to perform the identified task. This determination step can be mathematical calculation based on the number of lines of text and the translation productivity rate. With a mathematical calculation, it is a matter of dividing amount of text to be translated by the Translation Productivity Rate (TPR) to get a translation time in the number of days needed to perform the translation. Referring to FIG. 5, the translation time for a defined number of lines of Program Integrated Information (PII) is shown in the following equation:
Number of lines of PII÷Translation Productivity Rate=Performance Time.
Using line one of FIG. 5, the calculation is: 500 (lines)+200 (TPR)=2.125 days.

An alternate approach is to have the translation times for each volume internal pre-determined and have the resulting values for each calculation inserted in the table during the creation of the table. With this second approach, the method can retrieve the translation time value that corresponds to the desired amount of text and the translation rate. Referring again to FIG. 3, step 35 records the calculated time required to perform the identified task.

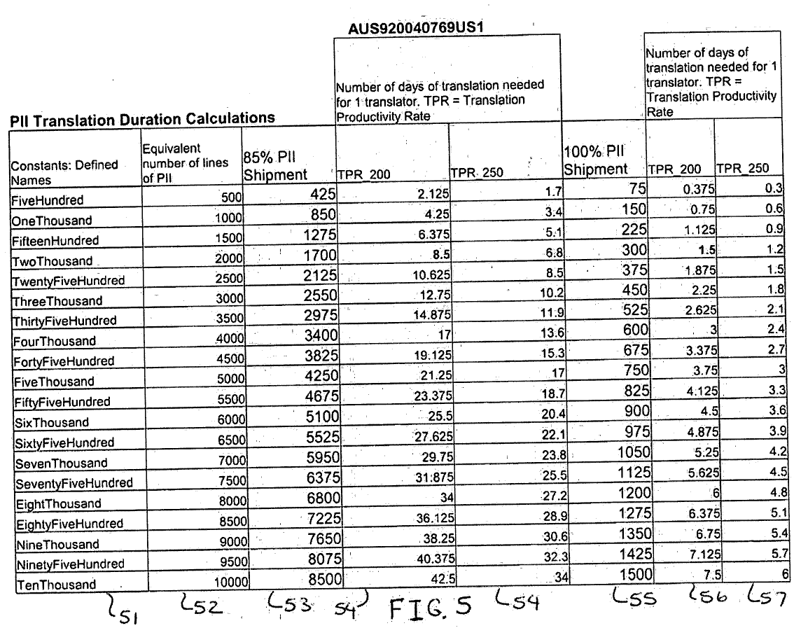

FIGS. 4 through 6 illustrate various forms of information that are contained in the sections of the tables used in the application of the method the present invention. FIG. 4 is a chart correlating production week to an equivalent number of days for each week. This table may be used in applications that require conversions between days and weeks.

FIG. 5 is an illustration of a translation table used to calculate the translation time for the purpose of generating a globalization schedule in accordance with the present invention. This table is related to the calculation of translation times for text data incorporated into a product. As previously mentioned, column 51 is a constant that identifies data amount intervals in numbers of lines of text. Column 52 is a number equivalent of the number of lines of text (PII). Column 53 is a calculation of 85 percent of the PII shipment of column 52. In FIG. 5, for the first row of 500 lines, 85 percent of that number is 425 lines. During the development of the project, the globalization phase may begin prior to having the complete set data that will be translated. Because the translation may take days, weeks or even months, translation jobs make be performed in sections. The 85 percent number is just an example of a percentage of data that may be sent out for translation prior to the completion of the entire project amount.

Columns 54 and 55 are calculated results based on the input data supplied by the user. These numbers are the days required to perform the translations for the various amounts of text and based on two different translation productivity rates. Column 54 shows translation times in days for a translation productivity rate of 200 lines per day. Column 55 shows translation times for a translation productivity rate of 250 lines per day. Columns 54 and 55 are for 85 percent of the translation amount.

Column 56 is a calculation of 15 percent of the PII shipment of column 52. This percentage number added to the number in column 52 equals 100 percent of the amount of lines that are to be translated in this process. In FIG. 5, for the first row of 500 lines, 15 percent of that number is 75 lines. Columns 57 and 58 are the translation calculations for the 75 lines and are based on the same translation rates as columns 54 and 55 respectively. As previously mentioned, the data in columns 54, 55, 57 and 58 can be calculated by the present method and inserted into the table or this data can be pre-calculated initially inserted when creating this table. Again the formula for determining the data in columns 54 and 55 is the number of lines in column 53 divided by the selected translation productivity rate (200 or 250 lines per day). The formula for calculating columns 57 and 58 is the number of lines in column 56 divided by the same selected translation productivity rate as column 54 or 55 respectively.

FIG. 6 is an illustration of a translation table used to calculate the translation time for the purpose of generating a globalization schedule for a volume of publication work in accordance with the present invention. Referring to the table, column 61 defines the various from which the user can identify the type of document for translation. As shown, there are several document types, which include, a User Guide, Installation Guide and Reference guide. This column 61 also includes translation rate parameters and defines an index of the number of days in a week. Column 62 contains the approximate number of words contained on each page of the document. In this table, column 63 contains the actual constant for the publication translation rate. The translation rate is 2000 words a day. Column 64 lists the total number of words for each type of document listed in column 61. Column 65 is a calculation of the number of days needed to perform the designated translations. For example, the User Guide has 150 words per page and a total of 30000 words. The calculation formula is to divide the total number of words by the translation rate. In this example, the 30000 words are divided by 2000. As shown in column 65, the total number of days to perform the translation is 15 days (column 65) or three weeks (column 66). Column 67 also illustrates the total number of weeks to perform the translation. Column 68 indicates the size of the document in pages.

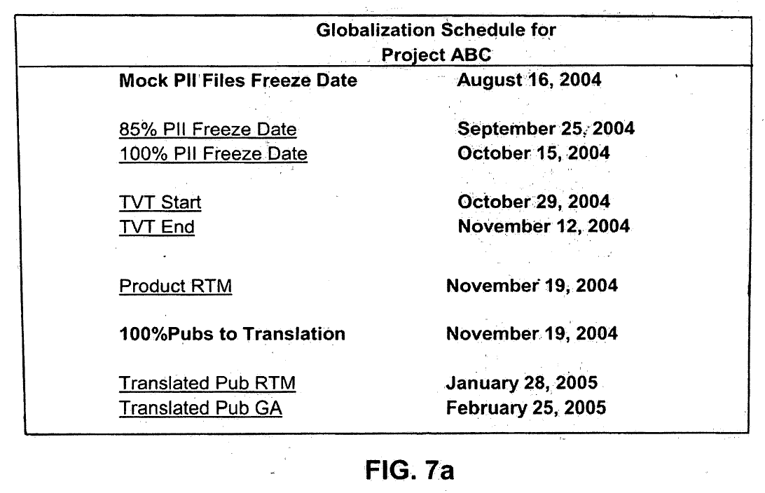

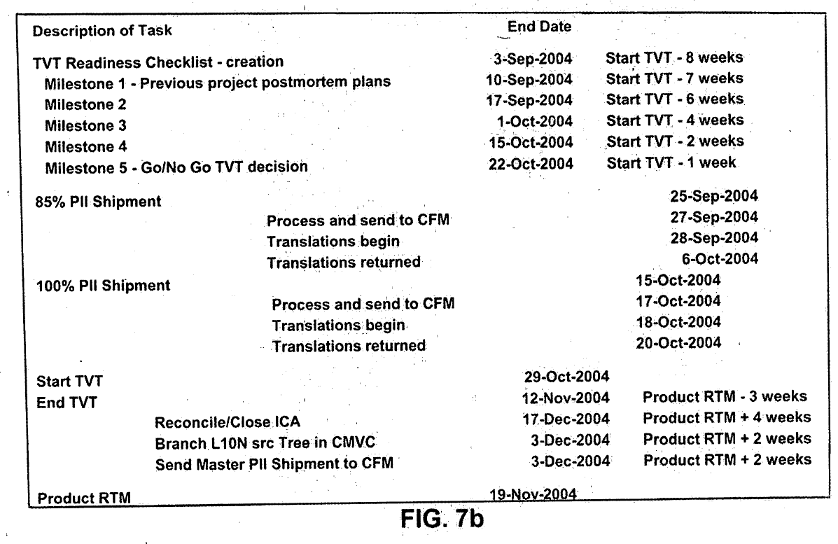

FIGS. 7a and 7b are illustrations of a scheduling report for a globalization project generated in accordance with the method of the present invention. As shown, FIG. 7a is a status report that lists several Globalization project activities and the start and end dates for each activity. This status report is an overview of the Globalization activities in the project, which is generally used for team and managerial meetings. FIG. 7b is a more detailed report of the day to day Globalization activities in the project, used by the Globalization Project Manager.

The information generated in accordance with the present invention can be presented on Microsoft Excel spreadsheets. Each display contains a set of display options for the various forms information that are generated from the present invention. The options include: Report, Details, and Constant options. The ‘Constants’ option will show the information in FIGS. 5 and 6. The ‘Report’ option will display FIG. 7a. The ‘Details’ option will display FIG. 7b. In addition, each Microsoft Excel display can have other options in the set that include Introduction, How to Use and Limitations options.

This present invention uses years of historical Globalization project data and develops formulas that can be used as industry standards for the calculation of translation time for English text, the translation time for publications and the time for the translation test of the internationalized product. These are three key factors in the generation of an overall Globalization schedule.

It is important to note that while the present invention has been described in the context of a fully functioning data processing system, those skilled in the art will appreciate that the processes of the present invention are capable of being distributed in the form of instructions in a computer readable medium and a variety of other forms, regardless of the particular type of medium used to carry out the distribution. Examples of computer readable media include media such as EPROM, ROM, tape, paper, floppy disc, hard disk drive, RAM, and CD-ROMs and transmission-types of media, such as digital and analog communications links.

Having thus described the invention, what we claim as new and desire to secure by Letters Patent is set forth in the following claims.

We claim:

1. A method for automatically generating a schedule for the performance of a task in a globalization project comprising the steps of:
creating a table containing a plurality of work volume intervals related to the performance of a task;
identifying a task to be performed as part of a globalization project;
identifying a specific volume of work for the identified task;
determining the amount of time required to perform the identified task; and
generating a work schedule for the performance of the identified task.

2. The method as described in claim 1 wherein the created table further comprises a productivity rate at which a task will be performed.

3. The method as described in claim 2 wherein the identified task to be performed is the translation of text from one language to a different language and the work volume comprises designed lines of text.

4. The method as described in claim 3 wherein the productivity rate is the number of lines that can be translated in a defined amount of time.

5. The method as described in claim 2 wherein said time determining step is calculated by the equation:
time to translate text=specific volume of work÷productivity rate

6. The method as described in claim 5 further comprising the step of recording the calculated time required to perform the specified amount of work in the created table.

7. The method as described in claim 1 wherein said schedule generating step further comprises calculating and end date for a task based on the date at which a project will start and the calculated time required to complete the task.

8. The method as described in claim 1 wherein the table is created in a spreadsheet format.

9. The method as described in claim 2 wherein the table further comprises multiple productivity rates.

10. The method as described in claim 9 further comprising before said time determining step, the step of identifying a desired productivity rate for the performance of the specified volume of work.

11. The method as described in claim 3 wherein the translation task can be for data in an electronic format or in a hardcopy format.

12. The method as described in claim 2 wherein said time determining step is calculated by the equation:
time to translate publications=((((words per page*number of pages)/words per day)/days in week)/number of translators).

13. A computer program product in a computer readable medium for automatically generating a schedule for the performance of a task in a globalization project comprising:
instructions for creating a table containing a plurality of work volume intervals related to the performance of a task;
instructions for identifying a task to be performed as part of a globalization project;
instructions for identifying a specific volume of work for the identified task;
instructions for determining the amount of time required to perform the identified task; and
instructions for generating a work schedule for the performance of the identified task.

14. The computer program product as described in claim 13 wherein the created table further comprises a productivity rate at which a task will be performed.

15. The computer program product as described in claim 14 wherein the identified task to be performed is the translation of text from one language to a different language and the work volume comprises designed lines of text.

16. The computer program product as described in claim 15 wherein the productivity rate is the number of lines that can be translated in a defined amount of time.

17. The computer program product as described in claim 14 further comprising the step of recording the calculated time required to perform the specified amount of work in the created table.

18. The computer program product as described in claim 13 wherein said schedule generating instructions further comprise instructions for calculating and end date for a task based on the date at which a project will start and the calculated time required to complete the task.

19. The computer program product as described in claim 14 further comprising before said time determining instructions, instructions for identifying a desired productivity rate for the performance of the specified volume of work.
